(19) United States
(12) Patent Application Publication
(10) Pub. No.: US 2005/0254435 A1
(43) Pub. Date: Nov. 17, 2005

(54) Method and system for selecting network connections in a multi-network environment

(76) Inventors: George P. Moakley, Phoenix, AZ (US); Steven L. Grobman, El Dorado Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/114,394

(22) Filed: Apr. 25, 2005

Related U.S. Application Data
(63) Continuation-in-part of application No. 10/746,897, filed on Dec. 23, 2003.

(51) Int. Cl. H04L 12/28

(52) U.S. Cl. 370/252

(57) ABSTRACT

A method and system for selecting network connections in a multi-network environment is described. The method includes determining one or more network connections coupled to a computing device, determining connection parameters associated with each network connection, and selecting the network connection with connection parameters that best match the connection requirements of an application on the computing device

### CROSS REFERENCE TO RELATED APPLICATION

This application is a continuation-in-part of application Ser. No. 10/746,897 filed Dec. 23, 2003.

### TECHNICAL FIELD

Embodiments of the invention relate to the field of network communication and more specifically to the selection of network connections in a multi-network environment.

### BACKGROUND

For a computing platform in a wired environment, the number of network connections available to an application matches the number of wired network connections attached to the computing platform. For personal computers (PCs), the number of network connections is usually one. However, a mobile data communications device, such as a notebook PC, tablet PC, or PDA, may encounter multiple network connection options as it moves through different environments, and each option may represent a different set of parameters, such as cost, bandwidth, latency and security level. Additionally, not all application services are available through all available network connections. Therefore, the user of a mobile data communications device in a multi-network environment may want to make use of different communication options available to the device as the options become available.

### BRIEF DESCRIPTION OF DRAWINGS

The present invention is illustrated by way of example, and not by limitation, in the figures of the accompanying drawings in which:

FIG. 1 is a block diagram illustrating one generalized embodiment of a device that may communicate using multiple network connections;

FIG. 2 is an exemplary connection table of a network connection utility;

FIG. 3 is a flow diagram corresponding to one embodiment of a technique for selecting one of multiple network connections; and

FIG. 4 is a block diagram of one embodiment of a computing environment.

### DETAILED DESCRIPTION

Embodiments of a system and method for enabling applications to select network connections in a multi-network environment are described. In the following description, numerous specific details are set forth. However, it is understood that embodiments of the invention may be practiced without these specific details. In other instances, well-known circuits, structures and techniques are not shown in detail in order not to obscure the understanding of this description.

Reference throughout this specification to “one embodiment” or “an embodiment” means that a particular feature, structure or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

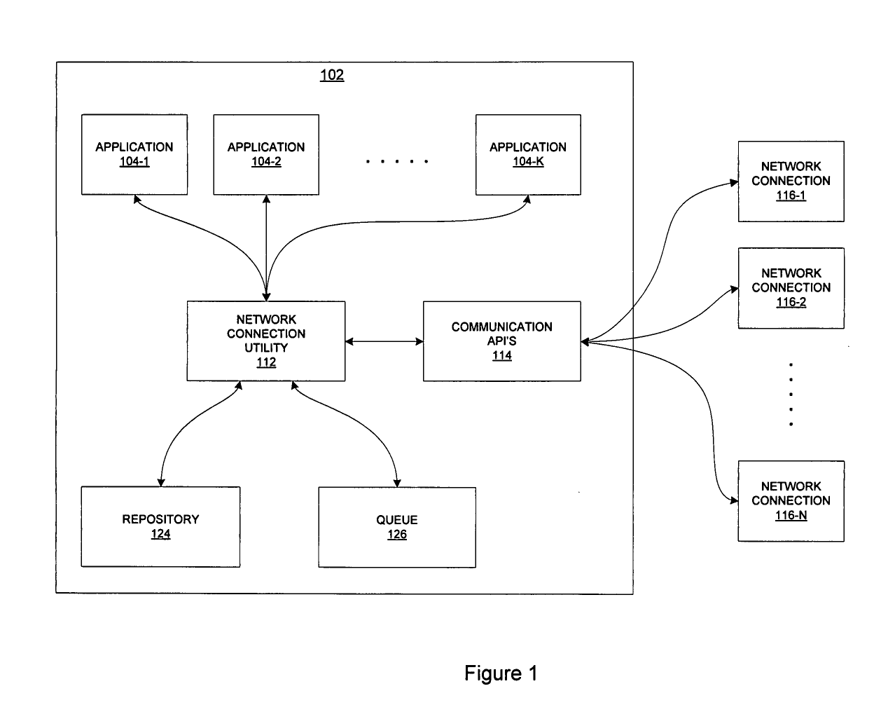

FIG. 1 illustrates a block diagram of one embodiment of a device 102 in a multi-network environment. Device 102 may include more components than those shown in FIG. 1. However, it is not necessary to show all of these generally conventional components in order to disclose an illustrative embodiment for practicing the invention.

Device 102 may be a mobile data communications device. For example, device 102 may be a computing or data processing device such as a notebook personal computer (PC), tablet PC, handheld computer, personal digital assistant (PDA), cellular telephone or the like. Device 102 may have one or more applications, such as applications 104-1 through 104-k, which may be, for example, one or more instances of an email application, a web browser application, a fax application, a voice over Internet protocol (VoIP) application or any application that may communicate over a network connection. Applications 104-1 through 104-k may communicate via one or more network connections, such as network connections 116-1 through 116-n, to interact with one or more remote applications and/or services (not shown), which may be, for example, peer-based, client-based or server-based applications and/or services. Network connections 116-1 through 116-n may act as gateways to allow interaction between applications 104-1 through 104-k running on device 102 and the remote applications and/or services. The network connections 116-1 through 116-n may be wired or wireless network connections. Examples of network connections include wired local area network connections conforming to IEEE Standard 802.3-2002, public or private wireless local area networks (WLAN) conforming to IEEE Standard 802.11-1997, mobile wireless data services such as GSM-GPRS conforming to ETSI Standard TS 101 350 V8.7.0 (2001-01) or cellular telephone networks such as GSM conforming to ETSI Standard TS 121 101 V.3.3.0 (2001-03), CDMA conforming to TIA Standard TIA-97-F or TDMA conforming to ANSI Standard ANSI-136.

In one embodiment, a network connection utility 112 resides in device 102 and may compare the communication requirements of each application 104-1 through 104-k with the communication parameters of available network connections 116-1 through 116-n. The network connection utility 112 may select one of network connections 116-1 through 116-n for each application 104-1 through 104-k that best meets the application's communication needs. The network connection utility 112 may also maintain communication sessions with the remote applications and-or services as network connections appear and disappear, to provide the appearance of a seamless and continuous communications environment. In one embodiment, the network connection utility 112 develops a profile for each of the applications 104-1 through 104-k and network connections 116-1 through 116-n and stores these profiles in a repository 124. These profiles may be derived from information pre-loaded by the user into the network connection utility 112 or from information provided to the network connection utility by the applications and/or the network connections monitored by the network connection utility 112. Such information may include, for example, the bandwidth needs of an application, the bandwidth available from a network connection, the latency of a network connection, the airtime cost of a network connection (e.g., per minute charges or per kilobyte charges), whether an application is a peer-to-peer, client or server application, the security level provided by a network connection, the availability of a network connection and whether a network connection is a local or wide area network connection.

In one embodiment, the network connection utility 112 may gather and compile a performance history for each network connection 116-1 through 116-n as the network connection is used by applications 104-1 through 104-k. Each application may connect with a network connection through communication application program interfaces (API's) 114, which insulate the requesting application from the details of the network connection. API's are known in the art and will not be described in detail, herein. The network connection utility 112 may determine which available network connection best suits the communication needs of the requesting application based, for example, on cost, bandwidth, latency, security and level of availability. The network connection utility 112 may query the network connection's service provider about the current connection and provide the data to the applications, which may use the data to make logical, cost-based and/or performance-based network connection decisions. For example, the network connection utility may detect that the only available network connection for an email client application is on a high cost network, and the email application could choose not to download a large file until a network becomes available with a lower cost for the download.

In one embodiment, a network connection may provide meta-data that characterizes the network connection through a bootstrapping mechanism. For example, the network connection may provide a uniform resource locator (URL) to a meta-data interface in the network connection utility (e.g., through a dynamic host control protocol (DHCP)), to ascertain network connection parameters such as cost, bandwidth, security, availability and the like. The best-suited network connection for the requesting application may then be selected by the network connection utility 112.

This technique provides a way for an application to obtain an arbitrarily complex data set, based on the unique characteristics of the application, to characterize a network connection and to understand the set of network resources that are available in order to maximize online and offline performance on a per application basis. For example, an Internet browser may use the meta-data to automatically use cached data for intranet sites and live data for Internet sites. Alternatively, if no suitable network connection is available (e.g., the application is offline or the connection is too costly or inadequately secured), the network connection utility 112 may queue an application's communications in a queue 126 until a suitable network connection is available. For example, in the email application discussed above, the application may start in an offline mode without attempting to connect to the mail service if an intranet or Internet connection is not available.

The network connection utility 112 may track the beginning and end of communication sessions between local applications running on the mobile device 102 (e.g., applications 104-1 through 104-k) and remote applications and/or services. This enables the network connection utility 112 to re-route a communication session between a local application and the remote applications and/or services in the event that a network connection is lost or a new network connection is encountered or regained that is better suited for the communication session (e.g. less expensive or lower latency). State information about the communication session may be maintained in a repository 124 to facilitate recovery should the network connection utility need to be restarted.

The network connection utility 112 has several components and functions. As noted above, the network connection utility 112 manages application communications and characterizes each application according to its communications needs. The network connection utility 112 may develop a profile for each application that includes information about the application's communications needs. The network connection utility 112 may monitor communications hardware, such as wireless network interface cards (NICs), to detect the appearance, disappearance and relative quality of network connections as they are acquired and lost. A list of each network connection and its associated parameters, such as cost, bandwidth, latency and security options, may be maintained. The application profiles and network connection profiles may be stored in the repository 124. When an application attempts to connect with a network, the network connection utility 112 may compare the application's communications requirements with the parameters of the network connections to determine which network connection is best suited to be used for the given communication. If no suitable network connection is available, the network connection utility 112 may queue that application's communications in queue 126 until a suitable network connection becomes available.

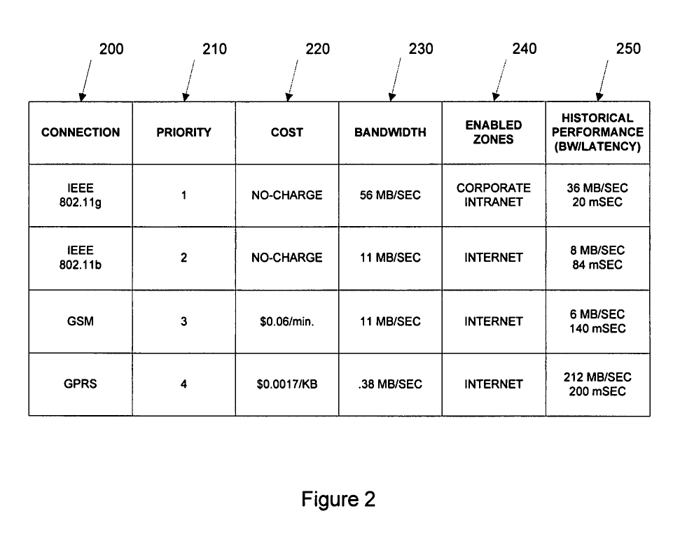

FIG. 2 is an exemplary connection table that may be maintained by the network connection utility 112. In the example shown, there are four available connections 200: an IEEE 802.11g WLAN connection, an IEEE802.11b WLAN, a GSM connection and a GPRS connection. Each connection 200 may have several associated connection parameters, such as cost 220, bandwidth 230, enabled communication zones 240 and historical performance 250, for example. The priority 210 of each connection, with respect to the requirements of an application, may be determined based on one or more of the connection parameters. The connections may be automatically configured using met-data as described above or configured via user intervention. The network connection utility 112 may select one of the network connections for an application's communications based on each connection's parameters and the communication requirements of the application. The connection that comes closest to matching the communication requirements of the application, without violating an absolute requirement, may be selected for each application's communications. For example, if lowest cost per kilobyte is an application's controlling selection criterion, the network with the lowest cost per kilobyte is selected. If a new network is detected by the network connection utility 112 and meta-data can ascertain that the new network is cheaper than an application's current connection, the network connection utility 112 will select the new network for the application's communications. In another example, if a maximum cost per kilobyte is an absolute requirement, then no connection may be selected if all available connections have a cost which is greater than the specified maximum. In general, the overall priority of a connection may be based on a single connection parameter or on a weighted or unweighted combination of connection parameters.

In the exemplary embodiment illustrated in FIG. 2, in an automatic detection and configuration mode as described above, the device 102 may connect to the highest priority connection available based on an evaluation of the connection parameters of each network connection as each network connection becomes available. In the example shown in FIG. 2, even if the fourth priority network is detected, it will not be selected if any of the first three are available. In addition, if the availability of the highest priority network connection is lost, the connection may be switched to the next highest priority network available. In FIG. 2, for example, the 802.11b WLAN connection is selected if the 802.11g corporate intranet is not available. Whenever an application is connected to one of the available connections, the actual performance of the connection may be monitored by the network connection utility 112 and used to update the historical performance data in the repository 124, where it may be used to break priority ties based on other connection parameters.

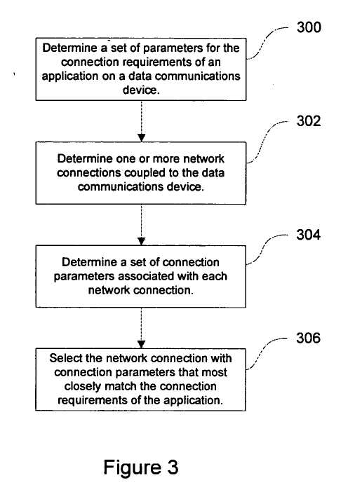

FIG. 3 illustrates a flow diagram corresponding to one embodiment of a technique for selecting one of multiple network connections. At 300, a set of parameters for the connection requirements of an application on a device is determined from an application profile maintained by the network connection utility 112 as described above. At 302, one or more network connections coupled to the device 102 are determined from the connection table maintained by the network connection utility 112 as described above.

At 304, network connection parameters associated with each network connection are determined from the connection table maintained by the network connection utility 112. The connection parameters may include, for example, a cost parameter, a latency parameter, a bandwidth parameter, an historical performance parameter and a security parameter. In one embodiment, the connection parameters of the network connections are automatically configured, for example, by obtaining meta-data from a connection service provider as described above. In another embodiment, one or more connection parameters of one or more network connections are configured via user intervention such as, for example, manual data entry, copying configuration files from communication devices (e.g., network interface cards) or downloading network connection parameters from a peer, client or server application.

At 306, the network connection with connection parameters that most closely matches the connection requirements of each application is selected from the available network connections. In one embodiment, the connection parameters (e.g., cost of airtime, bandwidth and historical performance) are prioritized according to requirements derived from the connection requirements of the application. Then, the network connections are prioritized and selected based on the priorities of the connection parameters. The network connection priorities may be established by manual user intervention, as described above, or provided automatically by user supplied or default configuration criteria provided by the application.

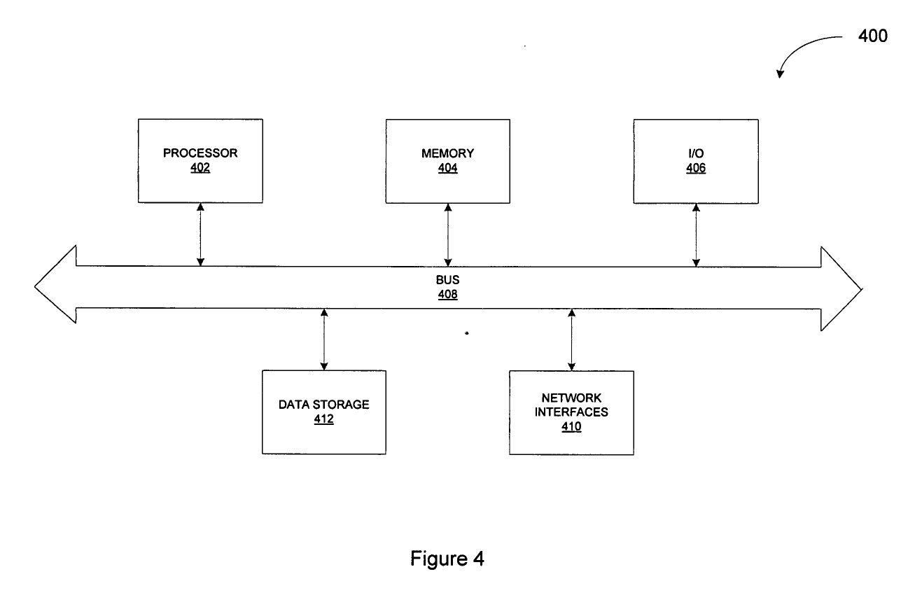

FIG. 4 is a block diagram illustrating one embodiment of a computing environment. In the exemplary embodiment, the method described above may be implemented on a computer system 400 having a processor 402, a memory 404, an input/output device 406, a data storage device 412, and a network interface 410, coupled to each other via a bus 408. The components perform their conventional functions known in the art and provide the means for implementing the device 102. Collectively, these components represent a broad category of hardware systems, including but not limited to general-purpose computer systems and specialized packet forwarding devices. Various components of computer system 400 may be rearranged, and certain implementations of the present invention may not require nor include all of the above components. Furthermore, additional components may be included in system 400, such as additional processors (e.g., a digital signal processor), storage devices, memories and network or communication interfaces.

The content for implementing an embodiment of the method of the invention, for example, computer program instructions, may be provided by any machine-accessible medium which can store data that is accessible by device 102, as part of or in addition to memory. Thus, a machine-accessible medium includes any mechanism that provides (i.e., stores and/or transmits) information in a form accessible by a machine (e.g., a computer, network device, personal digital assistant, manufacturing tool, any device with a set of one or more processors, etc.). For example, a machine-accessible medium includes recordable/non-recordable media (e.g., read only memory (ROM), random access memory (RAM), magnetic disk storage media, optical storage media, flash memory devices, etc.), as well as electrical optical acoustical or other form of propagated signals (e.g., carrier waves, infrared signals, digital signals, etc.), etc. In this regard, the device 102 is equipped to communicate with such machine-readable media in a manner well known in the art.

The content for implementing an embodiment of the method of the invention may be provided to the device 102 from any external device capable of storing the content and communicating the content to the device 102. For example, in one embodiment of the invention, the device 102 may be connected to a network, and the content may be stored on any device in the network.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

1. A method comprising:
determining one or more network connections coupled to a data communications device;
determining a plurality of connection parameters associated with each network connection; and
selecting the network connection with connection parameters that most closely matches one or more connection requirements of an application on the data communications device.

2. The method of claim 1, wherein selecting the network connection comprises selecting the network connection based on priorities of the connection parameters.

3. The method of claim 1, wherein determining the plurality of connection parameters associated with each network connection comprises configuring via user intervention one or more connection parameters associated with one or more of the network connections.

4. The method of claim 1, wherein determining the plurality of connection parameters associated with each network connection comprises automatically configuring the plurality of connection parameters with meta-data provided by the one or more network connections.

5. The method of claim 1, wherein the connection parameters include at least one of a cost parameter, a bandwidth parameter, a latency parameter, a security parameter or an historical performance parameter.

6. The method of claim 1, wherein determining the set of application parameters for the application comprises developing a profile for the application and storing the profile in a repository.

7. The method of claim 1, wherein determining the plurality of connection parameters associated with each network connection comprises developing a profile for the one or more network connections and storing the profile in a repository.

8. The method of claim 1, further comprising monitoring the application and the one or more network connections and maintaining communications with communications services as network connections appear and disappear.

9. The method of claim 1, further comprising tracking a communications session between the application and one of a remote application or service to reroute a communications session when a network connection is lost and a new network connection is encountered or regained, wherein the new network connection is best matched to the communication requirements of the application.

10. The method of claim 1, further comprising queuing communications of the application when no matching network connection is available.

11. An article of manufacture comprising:
a machine-accessible medium including content that when accessed by a machine causes the machine to perform operations comprising:
determining one or more network connections coupled to a data communications device;
determining a plurality of connection parameters associated with each network connection; and
selecting the network connection with connection parameters that most closely matches one or more connection requirements of an application on the computing device.

12. The article of manufacture of claim 11, wherein selecting the network connection comprises selecting the network connection based on priorities of the connection parameters.

13. The article of manufacture of claim 11, wherein determining the plurality of connection parameters associated with each network connection comprises configuring via user intervention one or more connection parameters associated with one or more of the network connections.

14. The article of manufacture of claim 11, wherein determining the plurality of connection parameters associated with each network connection comprises automatically configuring the plurality of connection parameters with meta-data provided by the one or more network connections.

15. The article of manufacture of claim 11, wherein the connection parameters include at least one of a cost parameter, a bandwidth parameter, a latency parameter, a security parameter or an historical performance parameter associated with each network connection.

16. The article of manufacture of claim 11, wherein determining the set of application parameters for the application comprises developing a profile for the application and storing the profile in a repository.

17. The article of manufacture of claim 11, wherein determining the plurality of connection parameters associated with each network connection comprises developing a profile for the one or more network connections and storing the profile in a repository.

18. The article of manufacture of claim 11, wherein the machine-accessible medium further includes content that when accessed by the machine causes the machine to perform operations further comprising monitoring the application and the one or more network connections and maintaining communications with communications services as network connections appear and disappear.

19. The article of manufacture of claim 11, wherein the machine-accessible medium further includes content that when accessed by the machine causes the machine to perform operations further comprising tracking a communications session between the application and one of a remote application or service to reroute a communications session when a network connection is lost and a new network connection is encountered or regained, wherein the new network connection is best matched to the communication requirements of the application.

20. The article of manufacture of claim 11, wherein the machine-accessible medium further includes content that when accessed by the machine causes the machine to perform operations further comprising queuing communications of the application when no matching network connection is available.

21. A system comprising:
a processor;
a network interface coupled to the processor; and
a machine-accessible medium including data that when accessed by the processor causes the processor to perform operations comprising:
determining one or more network connections coupled to a data communications device;
determining a plurality of connection parameters associated with each network connection; and
selecting the network connection with connection parameters that best matches one or more connection requirements of an application on the data communications device.

22. The system of claim 21, wherein determining the plurality of connection parameters associated with each network connection comprises configuring via user intervention one or more connection parameters associated with one or more of the network connections.

23. The system of claim 21, wherein determining the plurality of connection parameters associated with each network connection comprises automatically configuring the plurality of connection parameters with meta-data provided by the one or more network connections.
